(19) United States
(12) Patent Application Publication
(10) Pub. No.: US 2011/0052847 A1
(43) Pub. Date: Mar. 3, 2011

(54) ARTICLES OF MANUFACTURE FROM RENEWABLE RESOURCES

(76) Inventors: Danny H. Roberts, Clemson, SC (US); Joseph D. Gangemi, Seneca, SC (US); Young T. Kim, Central, SC (US)

(21) Appl. No.: 12/869,053

(22) Filed: Aug. 26, 2010

Related U.S. Application Data
(60) Provisional application No. 61/237,385, filed on Aug. 27, 2009.
(60) Provisional application No. 61/263,533, filed on Nov. 23, 2009.

(51) Int. Cl. B32B 1/00; C08K 3/34; C08K 5/07; C08K 5/09; B82Y 30/00

(52) U.S. Cl. 428/35.7; 524/445; 524/9; 524/361; 523/122; 524/322; 977/773

(57) ABSTRACT

The present invention provides an article of manufacture, e.g., a molded container, film or sheet, comprising a polylactide-based composite material. The composite material may comprise a renewable resource derived polylactide-based polymer matrix, naturally derived fiber reinforcement material, nanoclay, a natural oil, fatty acid, wax, or waxy ester, and optionally an inhibitory agent.

### CROSS-REFERENCE TO RELATED APPLICATIONS

This application claims priority from U.S. Provisional Application Ser. No. 61/237,385, filed Aug. 27, 2009, and U.S. Provisional Application Ser. No. 61/263,533, filed Nov. 23, 2009, the disclosures of which are hereby incorporated by reference herein in their entireties.

### FIELD AND BACKGROUND OF INVENTION

The present invention relates to molded containers, films, sheets, and other articles of manufacture formed from renewable resources.

The production of plastics from renewable resources has been a field of increasing interest for many years. One particular area of interest concerns the production of polyesters that may be formed from polymerization of lactic acid-based monomers. Specifically, ring-opening polymerization of lactide has shown promise in production of polymeric materials. Lactic acid-based materials are often of particular interest as the raw materials can be derived from renewable agricultural resources such as, corn, plant starches, and canes.

Various approaches have been taken in attempt to obtain lactide-based polymeric materials having desired product characteristics. For example, U.S. Pat. No. 5,744,516, U.S. Pat. No. 6,150,438, U.S. Pat. No. 6,756,428, and U.S. Pat. No. 6,869,985 disclose various lactide-based polymers and methods of forming the lactide-based polymers.

While improvements have been made in the field and in particular in regard to the formation of lactide-based materials suitable for a variety of applications, room for improvement still remains. For example, in addition to the need for improved products in terms of strength and other physical characteristics, gas diffusion/permeability, aesthetic characteristics, and the like, there is also a continuing need in the art to form more ecologically-friendly products such as products completely formed from or with renewable resources.

### SUMMARY OF THE INVENTION

The present invention provides an article of manufacture such as a molded container, film or sheet comprising a renewable resource derived polylactide-based composite material. The composite material may comprise a renewable resource derived polylactide-based polymer matrix, naturally derived fiber reinforcement material, nanoclay and derivatives thereof, a natural oil, fatty acids, wax, or waxy ester, and optionally an inhibitory agent.

### DETAILED DESCRIPTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Furthermore, any patent reference cited herein is hereby incorporated by reference in its entirety.

As discussed above, a composite renewable resource-derived polymeric material is provided and may include a lactide-based polymeric matrix, and an embodiment is derived from a renewable resource. For purposes of this disclosure, the term ‘lactide-based polymer’ is intended to by synonymous with the terms polylactide, polylactic acid (PLA) and polylactide polymer, and is intended to include any polymer formed via the ring opening polymerization of lactide monomers, either alone (i.e., homopolymer) or in mixture or copolymer with other monomers. The term is also intended to encompass any different configuration and arrangement of the constituent monomers (such as syndiotactic, isotactic, and the like). The lactide-based polymer may or may not be derived from a renewable resource.

In addition to a polymeric matrix in combination with a plurality of natural fibers, the polymeric composites disclosed herein can include any of a variety of environmentally friendly beneficial agents such as, for instance, anti-oxidation agents, anti-microbial agents, anti-fungal agents, and the like that can provide desired characteristics to products. In one embodiment, beneficial agents can also be derived from renewable resources. For example, a polymeric composite can include one or more inhibitory agents that can provide a formed polymeric structure with an improved capability in preventing or limiting the passage of damaging factors into, through, or across the finished products.

In one particular embodiment, all of the components of a polymeric composite material, e.g., the polymers, the fibers, and any added agent(s), can be combined and processed to form blended lactide polymer resin in the form of beads or pellets. Accordingly, the pre-formed resin pellets can be ready for processing in a product fabrication process. As such, a product formation process can not only be a low cost, low energy formation process, but can also be quite simple. Exemplary processes include injection blow molding, extrusion blow molding, stretch blow molding, and melt processing (e.g., into a film).

In general, a lactide-based polymeric matrix can be derived from lactic acid. Lactic acid is produced commercially by fermentation of agricultural products such as whey, cornstarch, potatoes, molasses, and the like. When forming a lactide-based polymer, a lactide monomer can first be formed by the depolymerization of a lactic acid oligomer. In the past, production of lactide was a slow, expensive process, but recent advances in the art have enabled the production of high purity lactide at reasonable costs. Such as described in WO 07/047,999A1 and U.S. Pat. No. 5,539,081.

One embodiment of a formation process can include formation of a lactide-based polymer through the ring-opening polymerization of a lactide monomer. In other embodiments, commercially available polymers, such as those exemplified below, can be used.

In one embodiment, the lactide-based polymeric matrix of a composite material can include a homopolymer formed exclusively from polymerization of lactide monomers. For example, lactide monomer can be polymerized in the presence of a suitable polymerization catalyst, generally at elevated heat and pressure conditions, as is generally known in the art. In general, the catalyst can be any compound or composition that is known to catalyze the polymerization of lactide. Such catalysts are well known, and include alkyl lithium salts and the like, stannous octoate, aluminum isopropoxide, and certain rare earth metal compounds as described in U.S. Pat. No. 5,028,667 and which is incorporated herein by reference. The particular amount of catalyst used can vary generally depending on the catalytic activity of the material, as well as the temperature of the process and the polymerization rate desired. Typical catalyst concentrations include molar ratios of lactide to catalyst of between about 10:1 and about 100,000:1, and in one embodiment from about 2,000:1 to about 10,000:1. According to one exemplary process, a catalyst can be distributed in a starting lactide monomer material. If a solid, the catalyst can have a relatively small particle size. In one embodiment, a catalyst can be added to a monomer solution as a dilute solution in an inert solvent, thereby facilitating handling of the catalyst and its even mixing throughout the monomer solution. In those embodiments in which the catalyst is a toxic material, the process can also include steps to remove catalyst from the mixture following the polymerization reaction, for instance one or more leaching steps.

In one embodiment, a polymerization process can be carried out at elevated temperature, for example, between about 950° C. and about 1200° C., or in one embodiment between about 1100° C. and about 1700° C., and in another embodiment between about 1400° C. and about 1600° C. The temperature can generally be selected so as to obtain a reasonable polymerization rate for the particular catalyst used while keeping the temperature low enough to avoid polymer decomposition. In one embodiment, polymerization can take place at elevated pressure, as is generally known in the art. The process typically takes between about 1 and about 72 hours, for example between about 1 and about 4 hours.

Polylactide homopolymer obtainable from commercial sources can also be utilized in forming the disclosed polymeric composite materials. For example, poly(L-lactic acid) available from Polysciences, Inc., Natureworks, LLC, Cargill, Inc., Mitsui (Japan), Shimadzu (Japan), or Chronopol can be utilized in the disclosed methods.

A lactide-based polymer matrix can include polymers formed from a lactide monomer or oligomer in combination with one or more other polymeric materials. For example, in one embodiment, lactide can be co-polymerized with one or more other monomers or oligomers derived from renewable resources to form a lactide-based copolymer that can be incorporated in a polymeric composite material. According to such an embodiment, the secondary monomers of the copolymer can be materials that are at least recyclable and, in one embodiment, completely and safely biodegradable so as to present no hazardous waste issues upon degradation of the copolymer. In one particular embodiment, a lactide monomer can be co-polymerized with a monomer or oligomer that is anaerobically recyclable, which can improve the recyclability of the copolymer as compared to that of a PLA homopolymer. For example, a poly(lactide-co-glycolide), a poly(lactide-co-caprolactone), a PLA-co-PHA, or the like may be utilized. Polylactide copolymers for use in the disclosed composite materials can be random copolymers or block copolymers, as desired.

In another embodiment, a polymeric composition can include a polymer blend. For example, a lactide-based polymer or copolymer can be blended with another polymer, for example a recyclable polymer such as polypropylene, polyethylene terephthalate, polystyrene, polyvinylchloride or the like.

In one embodiment, a polymer blend can be utilized including a secondary polymer that can also be formed of renewable resources, as can be PLA. For example, a polymer blend can include a PLA polymer or copolymer in combination with a polyhydroxy alkanoate (PHA). PHAs are a member of a relatively new class of biomaterials prepared from renewable agricultural resources through bacterial fermentation. A variety of PHA compositions are available under the trade name NODAX™ from DaniMer Scientific of Bainbridge, Ga.

The relative proportions of polymers included in a blend can generally depend upon the desired physical characteristics of the polymeric products that can be formed from the composite materials. For example, a polymeric blend can include a PLA homopolymer or co-polymer as at least about 50 percent by weight of the polymer blend. In another embodiment, a polymeric blend can include at least about 70 percent PLA by weight of the blend, or higher in other embodiments, for instance greater than about 80 percent PLA by weight of the blend. In one embodiment, the polylactide-based polymer matrix has a moisture content of less than 0.25 percent and may in another embodiment have a moisture content of less than 0.025 to 0.25 percent.

In addition to a lactide-based polymeric matrix, disclosed composite materials can also include a plurality of natural fibers that can be derived from renewable resources and can be biodegradable. Fibers of the composite materials can, in one embodiment, reinforce mechanical characteristics of the composite materials. For instance fibers can improve the strength characteristics of the materials. The natural fibers can offer other/additional benefits to the disclosed composites, such as improved compatibility with secondary materials, improved biodegradability of the composite materials, attainment of particular aesthetic characteristics, and the like.

Natural fibers suitable for use in the presently disclosed composites can include plant, mineral, and animal-derived fibers. Plant derived fibers can include seed fibers and multi-cellular fibers which can further be classified as bast, leaf, and fruit fibers. Plant fibers that can be included in the disclosed composites can include cellulose materials derived from agricultural products including both wood and non-wood products. For example, fibrous materials suitable for use in the disclosed composites can include plant fibers derived from families including, but not limited to dicots such as members of the Linaceae (e.g., flax), Urticaceae, Tiliaceae (e.g., jute), Fabaceae, Cannabaceae, Apocynaceae, and Phytolaccaceae families, and, in some embodiments, monocots such as those of the Agavaceae family.

In one embodiment, the fibers can be derived from plants of the Malvaceae family, and in one particular embodiment, those of the genera Hibisceae (e.g., kenaf, beach hibiscus, rosselle) and/or those of the genera Gossypieae (e.g., cottons and allies). Other examples are mycelia fibers of species such as Trametes versicolor may be used.

In one embodiment, cotton fibers can be utilized in the disclosed composites. In general, cotton fibers can first be separated from the seed and subjected to several mechanical processing steps as are generally known to those of skill in the art to obtain a fibrous material for inclusion in a composite. In another embodiment, cotton flock which has a reduced length and have average fiber lengths from 350μ to 1000μ may be used.

In another embodiment, flax fibers can be incorporated into the disclosed composites. Processed flax fibers can generally range in length from 0.5 to 36 microns with a diameter from 12-16 micrometers. Linseed, which is flax grown specifically for oil, has a well established market and millions of acres of flaxseed are grown annually for this application, with the agricultural fiber residue unused. Thus, agricultural production of flax has the potential to provide dual cropping, jobs at fiber processing facilities, and a value added crop in rotation.

In another embodiment, natural protein-based fibers can be used. Exemplary fibers may include silk or spider silk and derivatives thereof. Such protein-based fibers may enhance structural stability. Additionally, the fibers may be in a crude form, i.e., protein-based fibers from the cocoons of worms, bees or other insects.

Reinforcement fibers of a composite material can include bast and/or stem fibers extracted from plants according to methods generally known in the art. According to such embodiments, the inner pulp of a plant can be a useful byproduct of the disclosed methods, as the pulp can beneficially be utilized in many known secondary applications, for instance in paper-making processes. For instance, the fibrous reinforcement materials can include bast fibers of up to about 10 mm in length. For example, kenaf bast fibers between about 2 mm and about 6 mm in length can be utilized as reinforcement fibers.

A composite polymeric material can generally include a fibrous component in an amount of up to about 50 percent by weight of the composite. For example, a composite material can include a fibrous component in an amount between about 10 percent and about 40 percent by weight of the composite.

According to one embodiment, the fiber component of the composite materials can serve merely to provide reinforcement to the polymeric matrix and improve strength characteristics of the material. In other embodiments, the fibrous component can optionally or additionally provide particular aesthetic qualities to the composite material and/or products formed therefrom. For example, particular fibers or combinations of fibers can be included in a composite material to affect the opacity, color, texture, plasticity, and overall appearance of the material and/or products formed therefrom. For instance, cotton, kenaf, flax, as well as other natural fibers can be included in the disclosed composites either alone or in combination with one another to provide a composite material having a unique appearance and/or texture for any of a variety of applications.

Additionally the strength of the composite polymer material may be improved by the addition of nanoclay. Nanoclays are nanosized particles that are smaller than 100 nanometers (nm), namely particles that are smaller than 0.1 μm in any one direction. Exemplary materials include montmorillonite, pyrophyllite, hectorite, vermiculite, beidilite, seponite, kaolinites, and micas. The nanoclays may be naturally- or synthetically-derived, and can be intercalated or exfoliated. An exemplary natural nanoclay is available from Southern Clay Products. The composite polymer material may include 0 to 15 percent by weight of the nanoclay, and often 0.1 to 15 percent by weight nanoclay.

A naturally-derived oil, fatty acid, or wax such as a waxy ester can also be included in the composite polymer material. The term “naturally-derived oil” refers to any triglyceride derived from a renewable resource, such as plant material. Exemplary naturally-derived oils can include without limitation one or more coffee oil, soybean oil, safflower oil, tung oil, tall oil, calendula, rapeseed oil, peanut oil, linseed oil, sesame oil, olive oil, dehydrated castor oil, tallow oil, sunflower oil, cottonseed oil, corn oil, coconut oil, palm oil, canola oil, and mixtures thereof. Exemplary fatty acids are long chained saturated and unsaturated fatty acids, and may include myristoleic acid, palitoleic acid, oleic acid, linoleic acid, arachidonic acid, eicosapentaenoic acid, eruic acid, docsahesaenoic acid, lauric acid, myristic acid, palmitic acid, stearic acid, and arachidic acid.

As utilized herein, the term ‘waxy esters’ generally refers to esters of long-chain fatty alcohols with long-chain fatty acids. Chain lengths of the fatty alcohol and fatty acid components of a waxy ester can vary, though in general, a waxy ester can include greater than about 20 carbons total. Waxy esters can generally exhibit a higher melting point than that of fats and oils. For instance, waxy esters can generally exhibit a melting point greater than about 45° C. Additionally, waxy esters encompassed herein include any waxy ester including saturated or unsaturated, branched or straight chained, and so forth. Exemplary naturally-derived waxes and waxy esters can include without limitation, bees wax, jojoba oil, plant-based waxes, bird waxes, non-bee insect waxes, and microbial waxes.

The composite material composition may include 0 to 10 percent by weight of the naturally-derived oil, fatty acid, wax, or waxy ester, and often 0.1 to 10 percent by weight of the naturally-derived oil, fatty acid, wax, or waxy ester.

It is recognized by those skilled in the art that the naturally-derived oils, fatty acids, or waxes including waxy esters can be blended together or can be blended or replaced by synthetic equivalents.

In addition to a polymeric matrix nanoclay natural fibers, and a naturally-derived oil or naturally-derived wax, the polymeric composite material can include one or more inhibitory agents that can provide desirable characteristics to the material and/or products formed therefrom. For example, a composite can include one or more natural and/or biodegradable agents that can be derived from renewable resources such as anti-oxidants, antimicrobial agents, anti-fungal agents, ultra-violet blockers, ultra-violet absorbers, scavenging agents including free radical scavenging agents, and the like that can be completely and safely biodegradable. In one exemplary embodiment, one or more inhibitory agents can improve protection of materials on one side of the formed polymeric material from one or more potentially damaging factors. For instance, one or more inhibitory agents can provide increased prevention of the passage of potentially harmful factors (e.g., oxygen, microbes, UV light, etc.) across a structure formed of the composite material and thus offer improved protection of materials held on one side of the composite polymeric material from damage or degradation. In one embodiment, a composite polymeric material can be designed to release an inhibitory agent from the matrix as the composite degrades, at which time the inhibitory agent can provide the desired activity, e.g., anti-microbial activity, at a surface of the polymeric composite.

Exemplary inhibitory agents can include without limitation, one or more natural anti-oxidants such as turmeric, burdock, green tea, garlic, ginger, astaxanthum, chlorophylinn, chlorella, pomegranate, acai, bilberry, elderberry, ginkgo biloba, grape seed, milk thistle, lutein (an extract of egg yolks, corn, broccoli, cabbage, lettuce, and other fruits and vegetables), olive leaf, rosemary, hawthorn berries, chickweed, capsicum (cayenne), and blueberry pulp, extractives, and derivates thereof. In one embodiment, the antioxidant is turmeric or a turmeric derivative. An exemplary turmeric is available from Natural Products Innovations, LLC as SKO1BDA. In another embodiment, the antioxidant is a source of polyphenols such as plant-derived polyphenols from green tea leaves.

One or more natural anti-microbial agents can be included in a polymeric composite. For example, exemplary natural anti-microbial agents can include berberine, an herbal anti-microbial agent that can be extracted from plants such as goldenseal, coptis, barberry, Oregon grape, and yerba mensa. Other natural anti-microbial agents can include, but are not limited to, extracts of propolis, St. John's wort, cranberry, garlic, E. cochinchinensis and S. officinalis, as well as anti-microbial essential oils, such as those that can be obtained from cinnamon, clove, or allspice, and anti-microbial gum resins, such as those obtained from myrrh and guggul.

Other exemplary inhibitory agents that can be included in the composite materials can include natural anti-fungal agents such as, for example, tea tree oil and resveratrol (a phytoestrogen found in grapes and other crops), or naturally occurring ultraviolet light blocking compounds such as mycosporine-like amino acids found in coral.

Optionally, the composite polymeric materials can include multiple inhibitory agents, each of which can bring one or more desired protective capacities to the composite.

In general, an inhibitory agent such as those described above can be included in an amount of about 0.1 to 10 percent by weight of the composite material. In other embodiments, an agent can be included at higher weight percentage. In one embodiment, the preferred addition amount can depend on one or more of the activity level of the agents upon potentially damaging factors, the amount of material to be protected by a structure formed including the composite material, the expected storage life of the material to be protected, and the like. For example, in one embodiment, an inhibitory agent can be incorporated into a composite polymeric material in an amount of between about 1 μg/mL material to be protected/month of storage life to about 100 μg/mL material to be protected/month of storage life.

Beneficially, as the formation processes can be carried out at low processing temperatures as discussed in more detail below, many natural inhibitory agents can be successfully incorporated in the composite materials. In particular, inhibitory agents in which the desired activity could be destroyed during the high-temperature processing conditions necessary for many previously known composite materials can be successfully included in the disclosed materials as they can maintain the desired activity throughout the formation processes.

A composite polymeric material can optionally include one or more additional additives as are generally known in the art. For example, a small amount (e.g., less than about 5 percent by weight of the composite material) of any or all of plasticizers, stabilizers, fiber sizing, polymerization catalysts, or the like can be included in the composite formulations. In one embodiment, any additional additives to the composite materials can be at least recyclable and non-toxic, and, in one embodiment, can be formed from renewable resources.

The various components of a polymeric composite material can be suitably combined prior to forming a polymeric structure. For instance, in one embodiment, the components can be melt or solution mixed in the formulation desired in a formed structure and then formed into pellets, beads, or the like suitable for delivery to a formation process. According to this particular embodiment, a product formation process can be quite simple, with little or no measuring or mixing of components necessary prior to the formation process (e.g., at the hopper).

In one particular embodiment, a chaotic mixing method such as that described in U.S. Pat. No. 6,770,340 can be used to combine the components of the polymeric composite. A chaotic mixing process can be used, for example, to provide the composite material with a particular and selective morphology with regard to the different phases to be combined in the mixing process, and in particular, with regard to the polymers, the fibrous reinforcement materials, and the inhibitory agents to be combined in the mixing process. For example, a chaotic mixing process can be utilized to form a composite material including one or more inhibitory agents concentrated at a predetermined location in the composite, so as to provide for a controlled release of the agents, for instance a timed-release of the agents from the composite as the polymeric component of the composite material degrades over time.

Following combination of the various components, the composite polymeric material can be formed into a desired article of manufacture via a low energy formation process.

One exemplary formation process can include providing the components of the composite materials to a product mold and forming the product via an in situ polymerization process. According to this method, reinforcement fibers, the nanoclay, naturally derived oil, and one or more inhibitory agents, and the desired monomers or oligomers can be solution mixed or melt mixed in the presence of a catalyst, and the polymeric product can be formed in a single step in situ polymerization process. In one embodiment, an in situ polymerization formation process can be carried out at ambient or only slightly elevated temperatures, for instance, less than about 750° C. Accordingly, the activity of the inhibitory agents can be maintained through the formation process, with little or no loss in activity.

In situ polymerization can be preferred in some embodiments due to the more favorable processing viscosity and degree of mixing that can be attained. For example, a monomer solution can describe a lower viscosity than a solution of the polymerized material. Accordingly, a reactive injection molding process can be utilized with a low viscosity monomer solution though the viscosity of the polymer is too high to be processed similarly. In addition, better interfacial mixing can occur by polymerization in situ in certain embodiments, and better interfacial mixing can in turn lead to better and more consistent mechanical performance of the final molded structure.

A formation process can include forming a polymeric structure from a polymeric melt, for instance in an extrusion molding process, an injection molding process or a blow molding process. For purposes of the present disclosure, injection molding processes include any molding process in which a polymeric melt or a monomeric or oligomeric solution is forced under pressure, for instance with a ram injector or a reciprocating screw, into a mold where it is shaped and cured. Blow molding processes can include any method in which a polymer can be shaped with the use of a fluid and then cured to form a product. Blow molding processes can include extrusion blow molding, injection blow molding, and stretch blow molding, as desired. Extrusion molding methods include those in which a melt is extruded from a die under pressure and cured to form the final product, e.g., a film or a fiber.

When considering processes that include forming a structure from a melt, polymeric structures can be formed utilizing less energy than previously known melt processes. For example, melts can be processed at temperatures about 1000° F. lower than molding temperatures necessary for polymers such as polypropylene, polyvinlyl chloride, polyethylene, and the like. For instance, composite polymeric, melts as disclosed herein can be molded at temperatures between about 170° C. to about 180° C., about 100° C. less than many fiberglass/polypropylene composites.

In one embodiment, a composite polymeric material as disclosed herein can be formed as a container, and in one particular embodiment, a container suitable for holding and protecting environmentally sensitive materials such as biologically active materials including pharmaceuticals and nutraceuticals. For purposes of the present disclosure, the term ‘pharmaceutical’ is herein defined to encompass materials regulated by the United States government including, for example, drugs and other biologics. For purposes of the present disclosure, the term ‘nutraceutical’ is herein defined to refer to biologically active agents that are not necessarily regulated by the United States government including, for example, vitamins, dietary supplements, and the like.

As discussed above, a polymeric composite material can include one or more inhibitory agents that can prevent passage of one or more factors across a formed structure. Accordingly, the polymeric composite material can help to prevent the degradation of the contents of a container from damage due to for instance, oxidation, ultraviolet energy, and the like. For example, formed structures can include a natural anti-oxidant in the composite polymeric material and can be utilized to store and protect oxygen-sensitive materials, such as oxygen-sensitive pharmaceuticals or nutraceuticals, from oxygen degradation.

Formed structures incorporating the composite materials can include laminates including the disclosed composite materials as one or more layers of the laminate. For example, a laminate structure can include one or more layers formed of composite materials as herein described so as to provide particular inhibitory agents at predetermined locations in the laminate structure. Such an embodiment can, for instance, provide for a controlled release of the inhibitory agents, for instance a timed-release of an agent from the composite as the adjacent layers and the polymeric component of the composite material degrade over time. Barrier properties may also be increased by using a wax coating inside or outside of the vessel being utilized for spraying or dipping.

Alternatively the various extrusion, blow molding, injection molding, casting or melt processes known to those skilled in the art may be used to form films or sheets. Exemplary articles of manufacture include articles used to wrap, or otherwise package food or various other solid articles. The films or sheets may have a wide variety of thicknesses, and other properties such as stiffness, breathability, temperature stability and the like which may be changed based on the desired end product and article to be packaged. Exemplary techniques for providing films or sheets are described, for example, in U.S. Patent Publication Nos. 2005/0112352, 2005/0182196, and 2007/0116909, and U.S. Pat. No. 6,291,597, the disclosures of which are incorporated herein by reference in their entireties.

In an exemplary embodiment, a laminate can include an impermeable polymeric layer on a surface of the structure, e.g., on the interior surface of a container (e.g., bottle or jar) or package (e.g., blister pack for pills). In one particular embodiment, an extruded film formed from a composite polymeric material can form one or more layers of such a laminate structure. For example, an impermeable PLA-based film can form an interior layer of a container so as to, for instance, prevent leakage, degradation or evaporation of liquids that can be stored in the container. Such an embodiment may be particularly useful when considering the storage of alcohol-based liquids, for instance, nutraceuticals in the form of alcohol-based extracts or tinctures.

In another embodiment, a composite polymeric material can form a structure to contain and protect environmentally sensitive materials such as environmentally sensitive agricultural materials including processed or unprocessed crops. For example, a composite polymeric material can be melt processed to form a fiber or a yarns and the fibers or yarns can be further processed to form a fabric, for instance a woven, nonwoven, or knitted fabric, that can be utilized to protect and/or contain an environmentally sensitive material such as a recently harvested agricultural material or optionally a secondary product formed from the agricultural material.

In one embodiment, containers can be specifically designed for the agricultural material that they will protect and contain. For instance, containers can be particularly designed to contain a specific agricultural material, and the fibrous component of the composite used to form the container can be derived from that same agricultural material. For example, a composite polymeric material can include a degradable polymeric matrix and a plurality of cotton fibers. This composite material can then be melt processed to form a structure, e.g., a bag, a wrap, or the like specifically designed to contain and/or protect cotton. Similarly, a composite polymeric material can include a degradable, PLA-based polymeric component and a fibrous flax component, and the composite can form a container specifically designed for the containment/protection of either unprocessed or processed flax.

According to such an embodiment, even should the container be damaged, for instance punctured in the course of handling such that the contents come into contact with a portion of the container material, the contents, e.g., the cotton, flax, etc., can still be suitable and safe for further processing, in particular as the ‘contaminants’ that have inadvertently come into contact with the contents are naturally derived materials, and in the case of the fibrous components, derived from the same crop as the contents of the container.

The following examples will serve to further exemplify the nature of the invention but should not be construed as a limitation on the scope thereof, which is defined by the appended claims.

### EXAMPLES

### Example 1

A lactide-based polymeric matrix comprising 83.9 percent PLA, 12.0 percent nanoclay, 3.0 percent fiber, 0.1 percent turmeric, and 1.0 percent jojoba oil with color was prepared and underwent a Corona treatment.

### Example 2

Example 1 was prepared without color.

### Example 3

A lactide-based polymer matrix was formed comprising 88.9 percent PLA, 7.0 percent nanoclay, 3.0 percent fiber, 0.1 percent turmeric, and 1.0 percent jojoba oil.

### Comparative Example 1

A pure PLA composition was formed.

Each of Examples 1-3 and the Comparative Example were formed into a bottle.

The water vapor permeability of the bottles was measured using ASTM F1249 at a relative humidity of 100 percent and at 25° C. The results are summarized in Table 1.

TABLE 1

| Example | WVTR (eve) |
|---|---|
| 1 | 0.0118 |
| 2 | 0.0112 |
| 3 | 0.0254 |
| Comparative Example 1 | 0.0789 |

Thus the samples of the invention (Examples 1, 2, and 3) had improved WVTR as compared to pure PLA.

Various properties of bottle formed from Example 1 was compared to a PET bottle and a HDPE bottle. The results are provided in Table 2.

TABLE 2

| Property | Test | Test Method | Example 1 | PET | HDPE |
|---|---|---|---|---|---|
| Gas Permeability | OTR | ASTM D3985 | 0.0150 | 0.0340 | 0.2491 |
| | WVTR | ASTM F1249 | 0.0199 | 0.0100 | 0.0008 |
| Thermostability | T_{g (glass transition)} | ASTM E1356 | 57.7° C. | 74.19° C. | — |
| | T_{m (melting)} | ASTM D4419 | 149.0° C. | 248.1° C. | 131.7° C. |
| | T_{crystallization} | ASTM D3418 | 110.4° C. | 110.7° C. | — |
| | Thermo Stability Temp. | ASTM E831 | 73.6° C. | 81.7° C. | — |
| | | (modified) | | | |
| Physical Property | Compression | ASTM D642 | 495.1 (lbs)/0.1 (in.) | 281.1 (lbs)/0.1 (in.) | 150.0 (lbs)/0.1 (in.) |
| | (Froce/Deformation) test | | | | |
| Light | UV Test | 300-400 nm | Pass | Pass | Pass |
| Transmission | | scanning | | | |

Thus, the bottle of the invention (Example 1) has improved properties as compared to Conventional PET and HDPE bottles.

### Example 4

A lactide based polymeric matrix comprising 81.9 percent PLA, 12.0 percent nanoclay, 1.0 percent fiber, 0.1 percent turmeric, and 5.0 percent oleic acid was formulated and pelletized. All three PLA pellets were dried at 35° C. for 48 hr before extrusion film casting. A single screw film casting extruder (Killion Extruders Div., Davis Standard Co., West Midlands, UK) equipped with 20 cm wide slit casting die was used to make films. The extruder was equipped with a single screw with D=25 mm, L/D=24:1, where D and L are diameter and length of the screw, respectively. The wire mesh screen was removed for casting basic formula and the die slit was adjusted for various thickness films. The barrel had three heating zones and a 3 hp motor turning the screw. Film casting conditions are provided in Table 3. The temperatures of the three extruder heating zones were set at 149, 177, and 193° C., respectively. The screw speed for the samples was 5 to 30 rpm. An adapter was installed ahead of the barrel and its temperature was set at 193° C. Five heater cartridges, one thermocouple and one PLC controller were used to control the die temperature. The die temperature was fixed at 193° C. The chill roll was placed in 2 cm from the die and its temperature was kept at 18° C. by temperature controller. The film quenched by a chill roll and was transported to a pulling station using a nip roll. The speed of chill and nip rolls were controlled separately from the extruder using a dial and digital display. Finally, all extruded films were wound by an electric film winder at the speed of 5.1 to 10.1 fpm. Film thickness was measured using digital micrometer and presented the average of three measurements. The results are provided in Table 3.

TABLE 3
Operation conditions for film casting with single
screw extruder and resulted film thickness

| | Pure PLA^{a} | Example 4 |
|---|---|---|
| Zone 1 | 149° C. | 149° C. |
| Zone 2 | 177° C. | 177° C. |
| Zone 3 | 193° C. | 193° C. |
| Adapter | 193° C. | 193° C. |
| Die | 193° C. | 193° C. |
| Screw | 10 to 30 rpm | 5 to 15 rpm |
| Back pressure^{d} | 31.3 to 36.2 atm | 35.1 to 50.2 atm |
| Melt temperature^{e} | 186° C. | 185° C. |
| Take off | 5.1 to 10.1 fpm | 5.1 to 10.1 fpm |
| Gap | 3.51 cm | 3.51 cm |
| Layflat | 12.9 to 13.7 cm | 10.1 to 13.1 cm |
| Thickness | 63.5 to 200.1 μm | 70.1 to 204.2 μm |

^{a}Back pressure are not fixed value. It depends on the property of resin.
^{b}Melt temperature are not fixed value. It depends on the property of resin.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed. The following claims are provided to ensure that the present application meets all statutory requirements as a priority application in all jurisdictions and shall not be construed as setting forth the full scope of the present invention.

What is claimed:

1. An article of manufacture comprising a polylactide-based composite material, the polylactide-based composite material composition comprising:
a) 70 to 95 percent by weight of the composite material composition polylactide-based polymer matrix derived from a renewable resource;
b) 1 to 10 percent by weight of the composite material composition reinforcement fibers, wherein said fibers are derived from a renewable resource;
c) 0.1 to 15 percent by weight of the composite material composition nanoclay;
d) 0.1 to 10 percent by weight of the composite material composition naturally derived oil, fatty acid, wax, or waxy ester; and
e) optionally 0.1 to 10 percent by weight of the composite material composition inhibitory agent derived from a renewable resource.

2. The article of manufacture of claim 1, wherein the reinforcement fibers are selected from the group consisting of flax, kenaf, and cotton fibers.

3. The article of manufacture of claim 1, wherein the inhibitory agent is an antioxidant.

4. The article of manufacture of claim 3, wherein the antioxidant is turmeric or a derivative thereof.

5. The article of manufacture of claim 1, wherein the inhibitory agent is an anti-microbial agent or an anti-fungal agent.

6. The article of manufacture of claim 1, wherein the polylactide-based polymer matrix has a moisture content of less than 0.25 percent.

7. The article of manufacture of claim 1, wherein the naturally-derived oil, wax, or waxy ester is jojoba oil, bees wax, plant-based waxes, bird waxes, non-bee insect waxes, and microbial waxes.

8. The article of manufacture of claim 1, wherein the nanoclay is a nanoparticle less than 100 nm.

9. The article of manufacture of claim 1, wherein the fatty acid is oleic acid.

10. The article of manufacture of claim 1, wherein the nanoclay is intercalated or exfoliated.

11. The article of manufacture of claim 1, wherein the inhibitory agent is turmeric or a derivative thereof.

12. A molded container, film or sheet comprising a polylactide-based composite material, the polylactide-based composite material composition comprising:
a) a polylactide-based polymer matrix derived from a renewable natural resource;
b) renewable resource fibers;
c) a nanoclay;
d) a fatty acid; and
e) an inhibitory agent derived from a renewable resource.

13. The molded container, film or sheet of claim 12, wherein the reinforcement fibers are selected from the group consisting of flax, kenaf, and cotton fibers.

14. The molded container, film or sheet of claim 12, wherein the inhibitory agent is an antioxidant.

15. The molded container, film or sheet of claim 14, wherein the antioxidant is turmeric or a derivative thereof.

16. The molded container, film or sheet of claim 12, wherein the inhibitory agent is an anti-microbial agent or an anti-fungal agent.

17. The molded container, film or sheet of claim 13, wherein the fatty acid is oleic acid.

18. The molded container, film or sheet of claim 13, wherein the polylactide-based polymer matrix has a moisture content of less than 0.25 percent.

19. The molded container, film or sheet of claim 13, wherein the nanoclay is a nanoparticle less than 100 nm.

20. The molded container, film or sheet of claim 13, wherein the nanoclay is intercalated or exfoliated.

21. A molded container, film or sheet comprising a polylactide-based composite material, the polylactide-based composite material composition comprising:
a) 70 to 95 percent by weight of the composite material composition polylactide-based polymer matrix derived from a renewable resource;
b) 1 to 10 percent by weight of the composite material composition reinforcement fibers, wherein said fibers are derived from a renewable resource;
c) 0.1 to 15 percent by weight of the composite material composition nanoclay;
d) 0.1 to 10 percent by weight of the composite material composition naturally derived oil, fatty acid, wax, or waxy ester; and
e) optionally 0.1 to 10 percent by weight of the composite material composition inhibitory agent derived from a renewable resource.

22. The molded container, film or sheet of claim 21, wherein the reinforcement fibers are selected from the group consisting of flax, kenaf, and cotton fibers.

23. The molded container, film or sheet of claim 21, wherein the inhibitory agent is an antioxidant.

24. The molded container, film or sheet of claim 23, wherein the antioxidant is turmeric or a derivative thereof.

25. The molded container, film or sheet of claim 21, wherein the inhibitory agent is an anti-microbial agent or an anti-fungal agent.

26. The molded container, film or sheet of claim 21, wherein the fatty acid is oleic acid.

27. The molded container, film or sheet of claim 21, wherein the polylactide-based polymer matrix has a moisture content of less than 0.25 percent.

28. The molded container, film or sheet of claim 21, wherein the naturally-derived oil is selected from the group consisting of coffee oil, soybean oil, safflower oil, tung oil, tall oil, calendula, rapeseed oil, peanut oil, linseed oil, sesame oil, olive oil, dehydrated castor oil, tallow oil, sunflower oil, cottonseed oil, corn oil, coconut oil, palm oil, canola oil, and mixtures thereof.

29. The molded container, film or sheet of claim 21, wherein the naturally-derived oil, wax, or waxy ester is jojoba oil, bees wax, plant-based waxes, bird waxes, non-bee insect waxes, and microbial waxes.

30. The molded container, film or sheet of claim 21, wherein the nanoclay is a nanoparticle less than 100 nm.

31. The molded container, film or sheet of claim 21, wherein the nanoclay is intercalated or exfoliated.

32. The molded container, film or sheet of claim 31, wherein the inhibitory agent is turmeric or a derivative thereof.
